(19) United States
(12) Patent Application Publication
(10) Pub. No.: US 2020/0118221 A1
(43) Pub. Date: Apr. 16, 2020

(54) SYSTEM AND METHOD FOR MAKING GROUP DECISIONS

(71) Applicant: Athan Slotkin, Santa Monica, CA (US)

(72) Inventor: Athan Slotkin, Santa Monica, CA (US)

(21) Appl. No.: 16/161,605

(22) Filed: Oct. 16, 2018

(51) Int. Cl. G06Q 50/00; G06F 17/30; G06Q 30/06

(52) U.S. Cl. CPC G06Q 50/01; G06F 17/3053; G06F 3/0482; G06Q 30/0627; G06Q 2230/00; G06F 17/30867

(57) ABSTRACT

Systems and methods for facilitating decision-making in groups in regards to choosing between two or more possible choices are provided. The method includes creating a profile on a digital application using a graphical user interface coupled to an electronic device, wherein creating the profile includes inputting one or more preferences. The method further includes creating a poll, wherein creating the poll includes: selecting, using the graphical user interface, two or more possible choices, from a list of possible choices, to be voted on, selecting one or more secondary users to vote in the poll, in addition to a user creating the poll, and inviting the one or more secondary users to vote in the poll. The method additionally includes voting for one or more choices from the selected two or more choices and notifying the user and the one or more secondary users of a winner of the poll.

### CLAIM OF PRIORITY

This application is a United States non-provisional application and claims no priority to any previous patent or patent application.

### FIELD OF THE EMBODIMENTS

This invention relates to providing food suggestions and, in particular, to providing suggestions for group selections, via voting, to one or more users using user input, and scoring the suggestions based on the input.

### BACKGROUND OF THE EMBODIMENTS

Choosing a suitable restaurant for a group of individuals is not an easy tasks. Each person in the group has their own food preferences, allergies, acceptable price ranges, acceptable travel distances, and other criteria when it comes to restaurants. Because of this, it is often difficult for a consensus as to where to eat. This can lead to anxiety, anger, disgust, and, if no consensus can be reached, can lead to no restaurant being chosen, the group not going out together, and any possible restaurants losing any possible income they may have received from the group.

For at least these reasons, a simpler and more efficient means of facilitating the restaurant-selecting process is needed.

Examples of related art are described below:

U.S. Pat. No. 8,601,005 generally relates to a system and method described herein simplifies data entry by a subject of a structured blood glucose test as well as helps with dietary compliance by providing specific dietary suggestions to the user. The system includes a portable device configured to be possessed by the subject. The portable device has a location detection system configured to provide data indicative of the location of the subject. A food database provides to the portable device a list of food items that are limited based on foods available at the location, such as a restaurant. The portable device is configured to receive a selection from the list that is indicative of a food consumed by the subject. A blood glucose meter reads blood glucose readings from the subject. The food database is configured to store the blood glucose readings and information about the foods consumed by the subject. Compliance to a prescribed dietary regimen can be monitored by the user and/or a physician.

U.S. Pat. No. 8,903,708 generally describes a system and method for analyzing a menu. In one embodiment, a mobile device can obtain a digital version of a restaurant menu. A list of food criteria can be stored on the mobile device and tailored to a particular user of the mobile device. The restaurant menu can then be filtered using the stored list of food criteria to display a reduced version of the restaurant menu with items that conflict with the food criteria removed. In another embodiment, the digital version of the menu can be translated. For example, a destination language can be based on a language setting in the mobile device. A source language can either be entered by the user, determined automatically by comparing words in the menu itself against dictionaries in different languages, or by using geographic location of the restaurant.

U.S. Patent Publication No. 2012/0239683 generally describes a food-related website utilizes a method to recommend to a user food-related results based on a criteria entered by the user. The method can match criteria in food-related results to make suggestions to the user. The method can match criteria in other user's accounts to recommend food-related results that match the criterion and that the other user recommends. Food-related result can be a food, ingredient, recipe, meal, restaurant, drink, or the like.

U.S. Patent Publication No. 2013/0211814 generally describes a system and method are described for analyzing a menu. In one embodiment, a mobile device can obtain a digital version of a restaurant menu. A list of food criteria can be stored on the mobile device and tailored to a particular user of the mobile device. The restaurant menu can then be filtered using the stored list of food criteria to display a reduced version of the restaurant menu with items that conflict with the food criteria removed. In another embodiment, the digital version of the menu can be translated. For example, a destination language can be based on a language setting in the mobile device. A source language can either be entered by the user, determined automatically by comparing words in the menu itself against dictionaries in different languages, or by using geographic location of the restaurant.

U.S. Patent Publication No. 2014/0080102 generally describes a system and method for enabling a personal diet management service is disclosed. The system enables users to communicate with the system and receive recommendations throughout the day. The system recommends recipes and restaurants serving the recipes based on a plurality of factors comprising of the calorie and nutrient intake of the person for each meal, identified deficiencies based on the recommended daily intake among others. The system also allows user to communicate with restaurants for reserving tables and specifying any further requests.

U.S. Patent Publication No. 2016/0012513 generally describes a restaurant and food recommendation system includes: a database of user data including user identification and food preference data. The system receives a recommendation request from a user device including the user identification and location data and analyzes a plurality of the food preference data from a plurality of the users to determine a probabilistic relationship between either the restaurant ratings or the menu item ratings of at least two users. Using the probabilistic relationship between either the restaurant ratings or the menu item ratings of at least two users and further filtering based on the data related to the user dietary needs and the data related to cuisine type ratings associated with the requesting user, as well as filtering using the location data received in the recommendation request, the system generates a recommendation related to a restaurant or to a menu item for the requesting user.

U.S. Patent Publication No. 2016/0232625 generally describes systems and methods in which event planning using social networking enables an efficient implementation of planning an event, as well as minimizing network traffic and optimizing other technological aspects of life. Additional information acquired by sensors and other technology is able to improve the quality of the event planning Social network information as well as the additional information is able to be used to select aspects of the event such as time, location, and/or many other aspects of the event.

U.S. Patent Publication No. 2016/0342902 generally describes a method that includes identifying a graph of a social network, the graph including nodes and edges, each edge connects two nodes, some of the plurality of nodes represent members of the social network, some edges of the plurality of edges represent a relationship between two associated nodes, creating a first taste profile for a first member node, the taste profile identifying a first entity of interest to the first member, identifying a second member node based on an absence of a second taste profile for the second member node, the second member node is connected to the first member node, determining that the second member node is connected to the first member node, creating a second taste profile for the second member node using the first taste profile, and providing a recommendation to a member associated with the second member node based on the created second taste profile.

None of the art described above addresses all of the issues that the present invention does.

### SUMMARY OF THE EMBODIMENTS

According to an aspect of the present invention, a method for facilitating decision-making in groups of individuals in regards to choosing between two or more possible choices is provided. The method includes creating a profile on a digital application using a graphical user interface coupled to an electronic device, wherein creating the profile includes inputting one or more preferences. The method further includes creating a poll, wherein creating the poll includes: selecting, using the graphical user interface, two or more possible choices, from a list of possible choices, to be voted on, selecting one or more secondary users to vote in the poll, in addition to a user creating the poll, and inviting the one or more secondary users to vote in the poll. The method additionally includes voting for one or more choices from the selected two or more choices and notifying the user and the one or more secondary users of a winner of the poll. It is an object of the present invention to provide the method for facilitating decision-making in groups of individuals in regards to choosing between two or more possible choices, wherein the two or more possible choices are restaurant choices, and wherein the one or more preferences are food preferences.

It is an object of the present invention to provide the method for facilitating decision-making in groups of individuals in regards to choosing between two or more possible choices, wherein the food preferences include one or more preferences selected from the group consisting of: types of food that the user likes; types of food that the user does not like; types of food that the user is allergic to; types of food that the user cannot or will not eat; diet; price preferences;

social preferences; location preferences; and ownership preferences.

It is an object of the present invention to provide the method for facilitating decision-making in groups of individuals in regards to choosing between two or more possible choices, wherein the method further includes searching, using the graphical user interface and the digital application, for one or more restaurants based on one or more filter criteria.

It is an object of the present invention to provide the method for facilitating decision-making in groups of individuals in regards to choosing between two or more possible choices, wherein the one or more filter criteria includes one or more criteria selected from the group consisting of: location; menu; type of food; hours of operation; parking information; reviews; pricing information; whether a restaurant is part of a chain of restaurants; and whether a restaurant is in a hotel.

It is an object of the present invention to provide the method for facilitating decision-making in groups of individuals in regards to choosing between two or more possible choices, wherein creating the profile includes inputting one or more pieces of information pertaining to the user, wherein the one or more pieces of information pertaining to the user includes one or more pieces of information selected from the group consisting of: name; address; phone number; e-mail address; age; and profession.

It is an object of the present invention to provide the method for facilitating decision-making in groups of individuals in regards to choosing between two or more possible choices, wherein the method further includes adding one or more contacts using the digital application.

It is an object of the present invention to provide the method for facilitating decision-making in groups of individuals in regards to choosing between two or more possible choices, wherein creating the poll further includes creating a group, the group including the user and one or more secondary users.

It is an object of the present invention to provide the method for facilitating decision-making in groups of individuals in regards to choosing between two or more possible choices, wherein voting occurs for a specific timeframe after the poll opens for voting and wherein the method further includes selecting the timeframe.

It is an object of the present invention to provide the method for facilitating decision-making in groups of individuals in regards to choosing between two or more possible choices, wherein the method further includes displaying, to the user, on a display, a score of each restaurant in the list of restaurants.

It is an object of the present invention to provide the method for facilitating decision-making in groups of individuals in regards to choosing between two or more possible choices, wherein the score is calculated based on the food preferences of the user.

It is an object of the present invention to provide the method for facilitating decision-making in groups of individuals in regards to choosing between two or more possible choices, wherein the score is calculated based on the food preferences of the user and one or more of the secondary users.

According to another aspect of the present invention, a system for facilitating decision-making in groups of individuals in regards to selecting food establishments is provided. The system includes a first electronic device, including a memory, a processor configured to run a digital application, a display, and a graphical user interface, wherein the first electronic device enables a user to create a profile on the digital application, using the graphical user interface, wherein creating the profile includes inputting one or more food preferences, create a poll, using the graphical user interface, wherein creating the poll includes selecting, using the graphical user interface, two or more restaurants, from a list of restaurants, to be voted on, selecting, using the graphical user interface, one or more secondary users to vote in the poll, in addition to a user creating the poll, and inviting the one or more secondary users to vote in the poll, and vote for one or more restaurants from the selected two or more restaurants. The system further includes one or more second electronic devices, including a memory, a processor configured to run the digital application, a display, and a graphical user interface, wherein the first electronic device and the one or more second electronic devices are configured to notify the user and the one or more secondary users of a winner of the poll.

It is an object of the present invention to provide the system for facilitating decision-making in groups of individuals in regards to selecting food establishments, wherein the food preferences include one or more preferences selected from the group consisting of: types of food that the user likes; types of food that the user does not like; types of food that the user is allergic to; types of food that the user cannot or will not eat; diet; price preferences; social preferences;

location preferences; and ownership preferences.

It is an object of the present invention to provide the system for facilitating decision-making in groups of individuals in regards to selecting food establishments, wherein the first electronic device is further configured to enable the user to search, using the graphical user interface and the digital application, for one or more restaurants based on one or more filter criteria.

It is an object of the present invention to provide the system for facilitating decision-making in groups of individuals in regards to selecting food establishments, wherein the one or more filter criteria includes one or more criteria selected from the group consisting of: location; menu; type of food; hours of operation; parking information; reviews; pricing information; whether a restaurant is part of a chain of restaurants; and whether a restaurant is in a hotel.

It is an object of the present invention to provide the system for facilitating decision-making in groups of individuals in regards to selecting food establishments, wherein the first electronic device is further configured to enable the user to add one or more contacts using the digital application.

It is an object of the present invention to provide the system for facilitating decision-making in groups of individuals in regards to selecting food establishments, wherein creating the poll further includes creating a group, the group including the user and one or more secondary users.

It is an object of the present invention to provide the system for facilitating decision-making in groups of individuals in regards to selecting food establishments, wherein voting occurs for a specific timeframe after the poll opens for voting. It is an object of the present invention to provide the system for facilitating decision-making in groups of individuals in regards to selecting food establishments, wherein creating the poll further includes selecting the timeframe.

### BRIEF DESCRIPTION OF THE DRAWINGS

FIGS. 1-2 show a method for aiding in the selection of food decisions, according to an embodiment of the present invention.

FIG. 3 shows a system for aiding in the selection of food decisions, according to an embodiment of the present invention.

FIG. 4 shows a screenshot of the digital application of the present invention enabling a user to add one or more contacts, according to an embodiment of the present invention.

FIG. 5 shows a screenshot of the digital application of the present invention showing a voting page, according to an embodiment of the present invention.

FIG. 6 shows a screenshot of the digital application of the present invention showing a poll winning screen, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

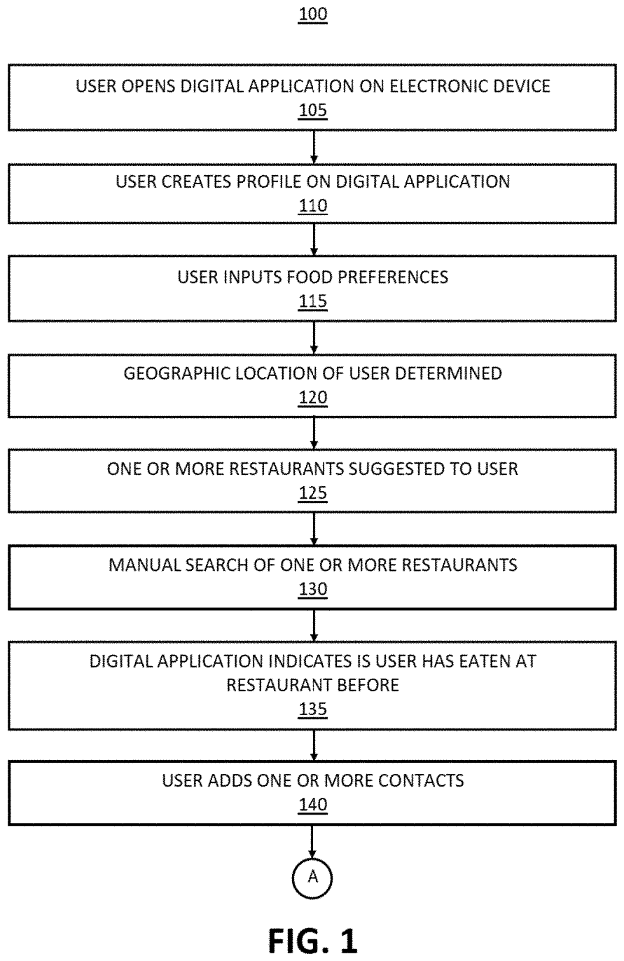

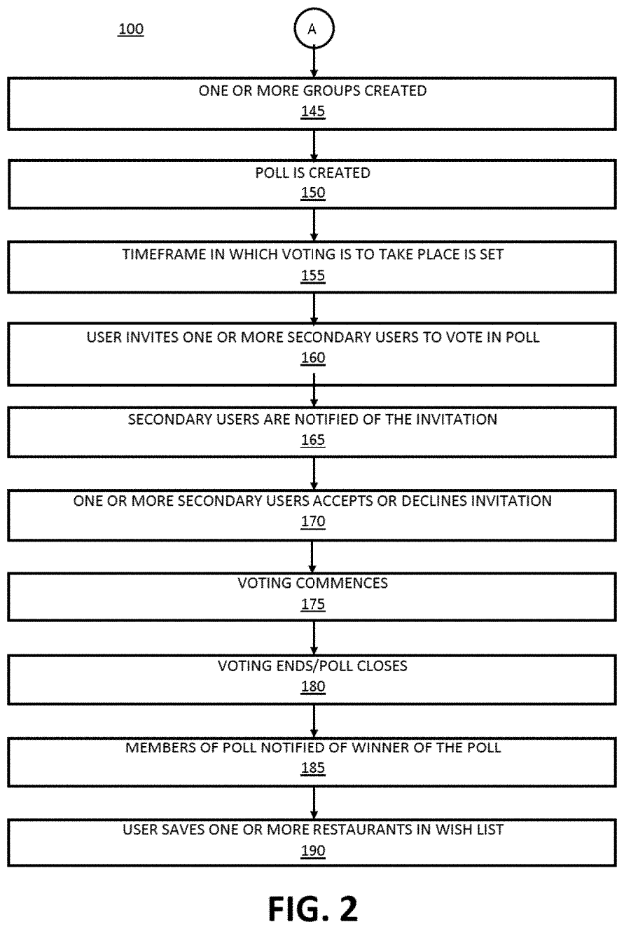

Referring now to FIGS. 1-2, a method 100 for aiding in the selection of food decisions is illustratively depicted, in accordance with an embodiment of the present invention.

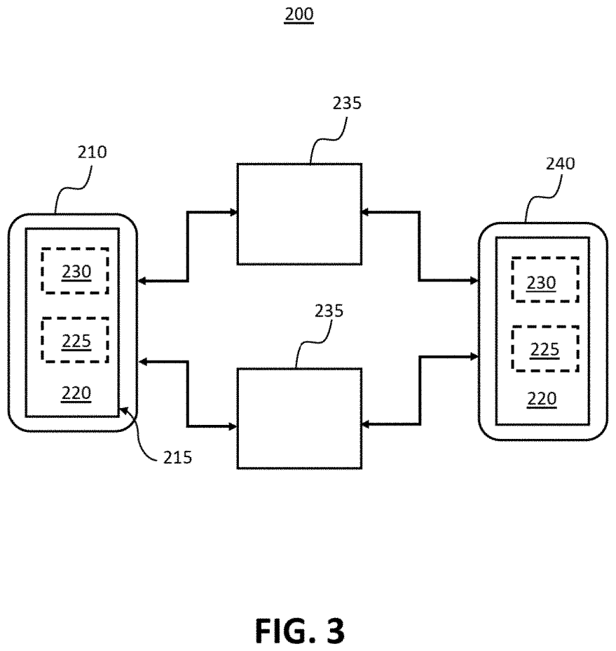

At step 105, a user opens a digital application on an electronic device 210 (as shown in system 200 of FIG. 3). According to an embodiment, the electronic device 210 may be a smart phone, a desktop computer, a laptop computer, a tablet computer, a gaming console, and/or any other suitable electronic device. According to an embodiment, the electronic device 210 includes a display 215 and a graphical user interface 220. According to an embodiment, the graphical user interface 220 is coupled to the display 215. According to an embodiment, the electronic device further includes a processor 225 and a memory 230.

At step 110, the user creates a profile on the digital application using the graphical user interface 220 of the electronic device 210. According to an embodiment, creating the profile includes inputting information pertaining to the user. The information pertaining to the user may include, e.g., the user's name, address, phone number, e-mail address, age, profession, and/or any other relevant information pertaining to the user.

At step 115, the user inputs food preferences. According to an embodiment, the food preferences may include types of food that the user likes, types of food that the user does not like, types of food that the user is allergic to, types of food that the user cannot and/or will not have, the user's diet, price preferences, social preferences, location preferences, ownership preferences, and/or any other suitable food preferences.

According to an embodiment, the digital application, at step 120, determines the geographical location of the user. According to an embodiment, this may be performed via GPS tracking, IP address tracking, manually inputting the location of the user using the graphical user interface, and/or any other suitable form of identifying the geographical location of the user. According to an embodiment, the digital application displays the user's location to the user using the display 215. According to an embodiment, the user is able to see, on the display 215, the location of one or more restaurants in relation to the user.

According to an embodiment, at step 125, using the food preferences input by the user and the geographical location of the user, the digital application suggests one or more restaurants at which the user may want to eat. According to an embodiment, each of the suggested restaurants include information pertaining to the restaurant such as, e.g., the restaurant's name, location, phone number, menu, hours of operation, average price, parking information, reviews, and/or any other relevant information pertaining to the restaurant. According to an embodiment, the suggested restaurants are scored based on the user's preferences and/or the preferences of one or more people in a group. According to an embodiment, the score refers to how close the restaurant is to the user's stated preferences.

According to an embodiment, the user, at step 130, may manually search for one or more restaurants, using the graphical user interface. According to an embodiment, the user may filter the search results based one or more relevant criteria such as, e.g., location, menu, type of food, hours of operation, parking information, reviews, pricing information, whether the restaurant is part of a chain of restaurants, whether the restaurant is in a hotel, and/or any other relevant criteria. The food types may include, e.g., Poke, Tacos, Dumplings, Salad, Sushi, Ramen, Burger, Chinese, Pizza, Thai, Seafood, Pho, Steak, Brekky, Italian, and/or any other relevant food types. According to an embodiment, the electronic device 210 is able to access the one or more restaurants via one or more remote servers 235. According to an embodiment, the electronic device 210 is coupled to the one or more remote servers 235 via a wired and/or wireless connection.

According to an embodiment, at step 135, the digital application marks whether a user has eaten at a particular restaurant before. According to an embodiment, the user manually inputs whether the user has eaten at a particular restaurant. According to an embodiment, the digital application may automatically designate whether the user has eaten at any restaurants. This information may help the user determine which restaurant to choose in case the user does or does not wish to eat at the same restaurant again.

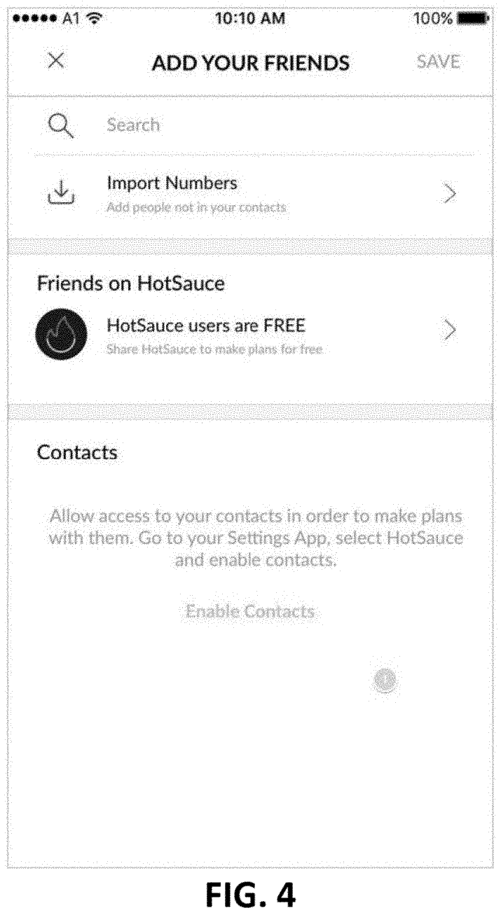

According to an embodiment, at step 140, the user may add one or more contacts/friends using the digital application (as shown in FIG. 4). According to an embodiment, if the contact has a profile with the digital application the user may add the user's contact information pertaining to the digital application. According to an embodiment, if the contact does not have a profile with the digital application, the user may add identifiable information pertaining to the contact such as, e.g., the contact's name, phone number, e-mail address, physical address, and/or any other relevant information. According to an embodiment, the user is able to view the food preferences of one or more of the contacts. According to an embodiment, the user, at step 145, may create one or more groups.

According to an embodiment, the members of the one or more groups may be selected from the one or more contacts and/or manually selected using identifiable information about the user. According to an embodiment, the members of the one or more groups may be added from the user's contacts.

At step 150, the user creates a poll. According to an embodiment, the poll includes two or more restaurant options. According to an embodiment, the user manually selects one or more of the restaurants in the poll. According to an embodiment, the digital application provides recommendations of one or more restaurants for the poll. According to an embodiment, the user makes the final decision as to which restaurants are in the poll. According to an embodiment, an administrator of the group makes the final decision as to which restaurants are in the poll. According to an embodiment, the digital application automatically chooses one or more restaurants in the poll. According to an embodiment, the poll includes scores for each of the restaurants according to each user's preferences and/or according to the preferences of the group as a whole. According to an embodiment, the group scoring is based on the preferences of users in the group who have profiles set up with the digital application.

According to an embodiment, at step 155, a timeframe is set in which the poll is to be completed. According to an embodiment, the user designates the timeframe in which the poll is to be completed. According to an embodiment, a default timeframe is used. According to an embodiment, the poll includes information pertaining to when the meal is to take place, such as, e.g., the date of the meal, the time of the meal, and/or any other relevant information pertaining to when the meal is to take place.

At step 160, the user selects one or more secondary users to invite to vote in the poll (along with the user). According to an embodiment, one or more of the secondary users have profiles with the digital application. According to an embodiment, one or more of the secondary users do not have profiles with the digital application. According to an embodiment, the one or more secondary users may be selected from the one or more contacts and/or the one or more groups. According to an embodiment, the user grants the digital application access to the user's contacts in the user's electronic device in order to add contacts to the user's profile in the digital application. According to an embodiment, one or more of the one or more secondary users access the digital application using one or more secondary electronic devices 240. According to an embodiment, the user's electronic device 210 and the one or more secondary electronic devices 240 are coupled via the one or more remote servers 235.

At step 165, the digital application notifies the one or more secondary users of the invitation to vote in the poll. The notification may be audible, visual, vibratory, and/or any other suitable form of notification. According to an embodiment, if the secondary user has a profile with the digital application, the digital application notifies the secondary user, using the digital application, that the user has an open poll. According to an embodiment, if the secondary user does not have a profile with the digital application, the digital application may notify the user by another means, such as, e.g., texting the user, emailing the user, and/or any other suitable form of notifying the user. Once the one or more secondary users are invited to vote in the poll, then, at step 170, the one or more secondary users accepts or declines the invitation to vote in the poll.

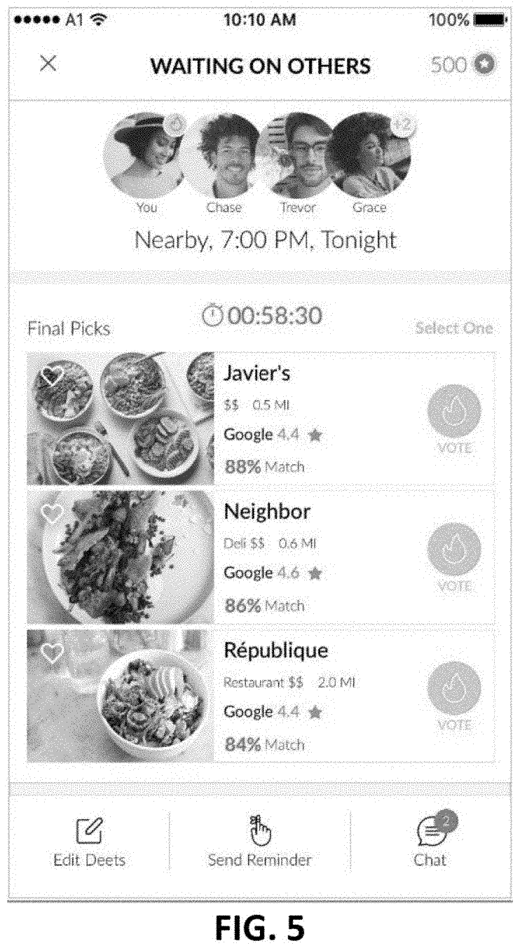

At step 175, voting commences for the poll. For any users and/or secondary users that have the digital application, these individuals may vote using the digital application. For any secondary users that do not have the digital application, these secondary users may vote using an alternative means such as, e.g., texting the response, e-mailing the response, and/or any other suitable means of voting. According to an embodiment, the digital application displays, on the graphical user interface, the options for the poll, the members of the poll, and/or the time left to vote (as shown in FIG. 5)

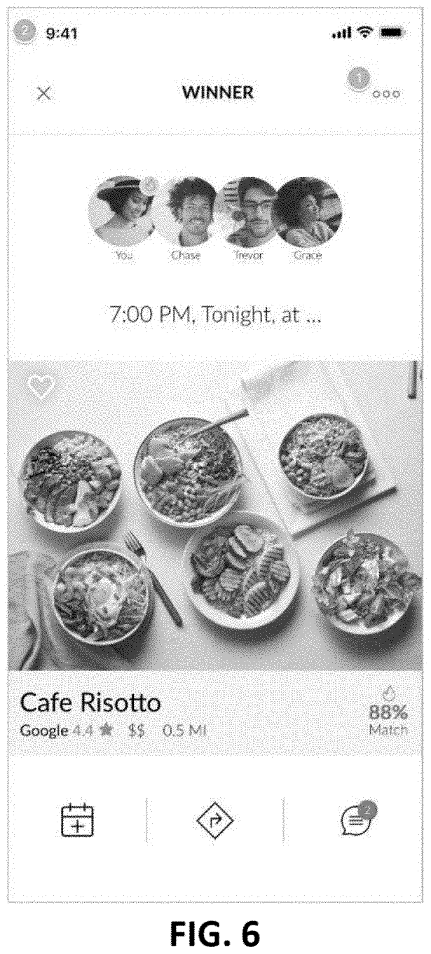

At step 180, voting ends and the poll closes. According to an embodiment, the poll ends at the completion of the predetermined timeframe in which the poll was to be completed. According to an embodiment, the poll ends when each person requested to vote in the poll has voted. Once voting has ended, each of the user and secondary users, at step 185, is notified of the winning restaurant in the poll. According to an embodiment, the notification informs the members of the poll of the time of the meal and the location of the meal (as shown in FIG. 6). By facilitating the process by which members of a group can determine which restaurant to eat at, and by facilitating the process is which a suitable restaurant is found, the present invention saves users time in making decisions, reduces the stress in making those decisions, and increases traffic to restaurants in which the individuals would have otherwise not been to. For at least these reasons, the present invention improves upon the existing technologies in this area.

The user may see restaurants at which the user desires to eat at a future time. At step 190, the user saves one or more restaurants to a wish list, which may be used for one or more future polls. It is noted that, according to various embodiments, a poll need not always be completed. According to an embodiment, the user may also have the ability to cancel a poll for any reason. According to an embodiment, each member of the poll is notified that a poll has been deleted.

Examples above pertain to choosing a food establishment at which one or more people will eat. However, it is noted that the system and method of the present invention may be used in any suitable suggestion- and/or voting-based query between one or more people, whether food related or not. Food-related categories and/or non-food-related categories may be used for voting using the present invention. For example, the query may be what hotel to stay at and the users may input hotel-related preferences and any suggested hotels may be scored based on the users' preferences on the hotels.

It is further noted that every method step need not be completed according to every embodiment of the present invention. Furthermore, the order of the steps may alter dependent on the embodiment of the present invention.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for facilitating decision-making in groups of individuals in regards to choosing between two or more possible choices, comprising:
creating a profile on a digital application using a graphical user interface coupled to an electronic device,
wherein creating the profile includes inputting one or more preferences;
creating a poll, wherein creating the poll includes:
selecting, using the graphical user interface, two or more possible choices, from a list of possible choices, to be voted on;
selecting one or more secondary users to vote in the poll, in addition to a user creating the poll; and
inviting the one or more secondary users to vote in the poll;
voting for one or more choices from the selected two or more choices; and
notifying the user and the one or more secondary users of a winner of the poll.

2. The method as recited in claim 1,
wherein the two or more possible choices are restaurant choices, and
wherein the one or more preferences are food preferences.

3. The method as recited in claim 2, wherein the food preferences include one or more preferences selected from the group consisting of: types of food that the user likes; types of food that the user does not like; types of food that the user is allergic to; types of food that the user cannot or will not eat; diet; price preferences; social preferences; location preferences; and ownership preferences.

4. The method as recited in claim 2, further comprising searching, using the graphical user interface and the digital application, for one or more restaurants based on one or more filter criteria.

5. The method as recited in claim 4, wherein the one or more filter criteria includes one or more criteria selected from the group consisting of: location; menu; type of food; hours of operation; parking information; reviews; pricing information; whether a restaurant is part of a chain of restaurants; and whether a restaurant is in a hotel.

6. The method as recited in claim 1, wherein creating the profile includes:
inputting one or more pieces of information pertaining to the user,
wherein the one or more pieces of information pertaining to the user includes one or more pieces of information selected from the group consisting of: name; address; phone number; e-mail address; age; and profession.

7. The method as recited in claim 1, further comprising adding one or more contacts using the digital application.

8. The method as recited in claim 1, wherein creating the poll further includes:
creating a group, the group including the user and one or more secondary users.

9. The method as recited in claim 1, wherein voting occurs for a specific timeframe after the poll opens for voting and wherein the method further includes selecting the timeframe.

10. The method as recited in claim 1, further comprising:
displaying, to the user, on a display, a score of each restaurant in the list of restaurants.

11. The method as recited in claim 10, wherein the score is calculated based on the food preferences of the user.

12. The method as recited in claim 10, wherein the score is calculated based on the food preferences of the user and one or more of the secondary users.

13. A system for facilitating decision-making in groups of individuals in regards to selecting food establishments, comprising:
a first electronic device, including:
a memory;
a processor configured to run a digital application;
a display; and
a graphical user interface,
wherein the first electronic device enables a user to:
create a profile on the digital application, using the graphical user interface,
wherein creating the profile includes inputting one or more food preferences;
create a poll, using the graphical user interface, wherein creating the poll includes:
selecting, using the graphical user interface, two or more restaurants, from a list of restaurants, to be voted on;
selecting, using the graphical user interface, one or more secondary users to vote in the poll, in addition to a user creating the poll; and
inviting the one or more secondary users to vote in the poll; and
vote for one or more restaurants from the selected two or more restaurants; and
one or more second electronic devices, including:
a memory;
a processor configured to run the digital application;
a display; and
a graphical user interface,
wherein the first electronic device and the one or more second electronic devices are configured to notify the user and the one or more secondary users of a winner of the poll.

14. The system as recited in claim 13, wherein the food preferences include one or more preferences selected from the group consisting of: types of food that the user likes; types of food that the user does not like; types of food that the user is allergic to; types of food that the user cannot or will not eat; diet; price preferences; social preferences; location preferences; and ownership preferences.

15. The system as recited in claim 1, wherein the first electronic device is further configured to enable the user to search, using the graphical user interface and the digital application, for one or more restaurants based on one or more filter criteria.

16. The system as recited in claim 15, wherein the one or more filter criteria includes one or more criteria selected from the group consisting of: location; menu; type of food; hours of operation; parking information; reviews; pricing information; whether a restaurant is part of a chain of restaurants; and whether a restaurant is in a hotel.

17. The system as recited in claim 13, wherein the first electronic device is further configured to enable the user to add one or more contacts using the digital application.

18. The system as recited in claim 13, wherein creating the poll further includes:
creating a group, the group including the user and one or more secondary users.

19. The system as recited in claim 13, wherein voting occurs for a specific timeframe after the poll opens for voting.

20. The system as recited in claim 19, wherein creating the poll further includes:
selecting the timeframe.
